(19) United States
(12) Patent Application Publication
(10) Pub. No.: US 2020/0272992 A1
(43) Pub. Date: Aug. 27, 2020

(54) MULTIPLE PROJECT VISUALIZATION TOOL

(71) Applicant: PORTFOLIO PLANNER APS, Ostbirk (DK)

(72) Inventor: Daniel HOJER, Ostbrik (DK)

(21) Appl. No.: 16/650,203

(22) PCT Filed: Sep. 26, 2018
(86) PCT No.: PCT/DK2018/050234

§ 371 Date: Mar. 24, 2020

(30) Foreign Application Priority Data
Sep. 26, 2017 (DK) PA 2017 70728

(51) Int. Cl. G06Q 10/10; H04L 29/06; G06F 3/0482

(52) U.S. Cl. CPC G06Q 10/103; G06F 3/0482; H04L 63/10

(57) ABSTRACT

A method of visualising project management information deriving from a plurality of mutually incompatible project management computer programs is presented. The method comprises the steps of obtaining first project data in a first data format generated by a first project management computer program, and obtaining second project data in a second data format generated by a second project management computer program. The first project data and second project data are deciphered and simultaneously visualised in a single graphical user interface of a project management computer program. The first data format is incompatible with the second project management computer program and the second data format is incompatible with the first project management computer program.

### TECHNICAL FIELD

The present invention relates to the field of computer programs for project management and visualization.

### BACKGROUND OF THE INVENTION

In the field of project planning, projects are often planned and managed with the help of specialised computer programs such as, e.g., Microsoft® Project® and Primavera Project Management. The projects may concern any kind of organised activities with specified periods for execution of certain tasks. The projects may be concerned with, e.g., construction of infrastructure and buildings, implementation of organizational changes, manufacturing of trade goods, etc. While the users formulating the plans of the projects often rely on the advanced functionality of these tools, a large group of, e.g., Portfolio/Program Managers, Project Managers, Project members, Line Managers, sub-contractors and men in the field need only certain extracts of information and not the full functionality of the advanced tools. Indeed, the advanced functionality of the specialised computer programs may work to hinder effective retrieval of information for this group.

Also, in collaborative projects, be that within or amongst organisations, different specialised computer programs may be used for the planning of different parts of the project. For instance, the overall project may be planned by one contractor responsible for the overall process of the project by use of a first computer program such as, e.g., Primavera Project Management or Safran Project, while a subcontractor responsible for a sub project may plan the sub project by use of a second computer program such as, e.g., Microsoft® Project® or Microsoft® Excel®. In general, these computer programs are not configured to communicate across platforms and commonly, a file written by the first computer program cannot be read by the second computer program. Accordingly, a project manager looking into the details of the sub project and at the same time trying to map the interdependence between the sub project and other elements of the overall project needs to have both computer programs available and to run the computer programs in parallel, while comparing projects between computer programs likely having different user interfaces.

### SUMMARY OF THE INVENTION

Embodiments of the invention provide a method of visualising project management information deriving from a plurality of mutually incompatible project management computer programs, comprising the steps of:
obtaining first project data in a first data format generated by a first project management computer program;
obtaining second project data in a second data format generated by a second project management computer program;
deciphering the first project data and second project data; and
simultaneously visualising the first project data and the second project data in a single graphical user interface of a project management computer program,
   wherein
the first project data comprises first project activity data defining a plurality of first project activities, at least one first project activity defining a set of activity parameters including at least start and finish time, budgeted units and/or one or more resources;
the second project data comprises second project activity data defining a plurality of second project activities, at least one second project activity defining a set of activity parameters including at least start and finish time, budgeted units and/or one or more resources; and
the first data format is incompatible with the second project management computer program and the second data format is incompatible with the first project management computer program.

Thanks to the provisions of simultaneous visualisation of the first project data and the second project data in the single graphical user interface of the project management computer program, the first and second project data are readily comparable, even though the first and second project data derive from mutually incompatible project management computer programs. This allows not only comparing static views of a certain first project activity in the first project data with another second project activity in the second project data, but also to navigate and obtain an overview of both first and second project data in the single graphical user interface. In the often complicated task of managing projects, such comparative capabilities may provide improved effectivity and convenience for several groups of users. Further, in case the first project data and second project data share a certain project activity, perhaps at different levels of detail, the simultaneous visualisation of the first project data and second project data in the single graphical user interface allows for simultaneous inspection of the shared project activity at different levels of detail in the first project data and the second project data.

Embodiments of the invention further provide a project management computer program carrying out the steps of the method as described with respect to the first aspect of the invention.

By simultaneously visualising the first and second project data of incompatible data formats, the need for opening each of the first and second project data in respective incompatible project management computer programs is alleviated. This may reduce the time spend and the amount of errors made when comparing the first and second project data, as project data no longer needs to be compared amongst the different individual user interfaces of the incompatible project management computer programs. Different user interfaces of incompatible project management computer programs are likely to be operated differently and project data may be presented differently in the different programs, causing cumbersome comparison of project data with a need for a user to familiarise multiple graphical user interfaces. Further, the single graphical user interface allows relevant project data to be visualised alongside with a minimised distance between related project data from otherwise incompatible sets of project data.

In present context, the term ‘data format’ refers to a database in a certain format, a file in certain format or a combination thereof

In embodiments of the invention, the single graphical user interface comprises dedicated view areas, such as a dedicated project navigation pane and a dedicated timeline pane. The simultaneous visualisation then allows individual selection of project activities from the first and second project data, and visualisation of the selected project activities of both the first and second project data in the single dedicated timeline pane. For a user, this means less distance between relevant information to be compared in the user interface. This minimisation of distance may decrease the time spend by a user comparing project data and decrease the number of errors made in comparison of project data.

The step of deciphering the first and second project data may comprise reading the first and second project data in the first and second data format in accordance with a specified set of rules for each of the first and second data format. Moreover, detailed knowledge of the first and second data formats including how the project data is organised, the order in which the project data is stored, how the data is stored and what units are used form part of the specific set of rules. For instance, the first data format may use a first time format, while the second format uses a second time format. The specified set of rules takes such differences into account and allows visualisation of the first and second project data in the same time format. The specified set of rules also takes into account if the first project data is saved as a database in the first data format or stored as a file, and similarly for the second project data.

The method may comprise the steps of obtaining, deciphering and visualising further sets of project data, enabling simultaneous visualisation of a multitude of sets of project data. The further sets of project data may be in the same data format as the first or second project data, or not. The method according to present invention accordingly may provide an even more versatile tool of comparing, navigating and interrelating project data.

In one embodiment, the obtained first project data in the first data format and the second project data in the second data format may be stored in a temporary memory of a computer only, such as in the random-access memory (RAM) of the computer. In this embodiment, deciphering and reading the project data may be relatively quick.

In one embodiment, the first and/or second set of activity parameters include at least also budgeted units and one or more resources.

The obtainment and deciphering of the first and second project data is done with little or no loss of detail. Accordingly, for each of the first and second project data, the project activity parameters defining at least start and finish time, budgeted units and one or more resources for at least one project activity are preserved. This allows for detailed visualisation of the first and second project data as well as statistical analyses of the first and second project data, all via the single graphical user interface. The start and finish time defines the time span of the project, while the budgeted units defines, e.g., a budgeted number of man hours or a budgeted amount of money for the project activity. The resources refer to resources occupied by a given project activity, such as, e.g., specified personnel or equipment required for the given project activity. For example, a project activity being part of a construction site project may define the number and type of construction workers, engineers and construction equipment needed, as well as the start and finish time and the budgeted man hours for the project activity.

In one embodiment, the method further comprises the step of storing third project data, the step of storing the third project data comprising the steps of:
copying the first and second project data;
storing the copied first and second project data; and
storing data indicative of where the first project data in the first data format is stored and where the second project data in the second data format is stored.

By copying and storing the copied first and second project data in the third project data, the first project data in the first data format and the second project data in the second data format are available to be opened by other project management computer programs, while being visualised in the single graphical user interface. This allows for one user, e.g. a project planner, to edit parts of the first and second project data, while another user, e.g. a contractor, is simultaneously visualising the first and second project data for carrying out a project activity. Further, by storing the copied first and second project data in the third project data, the third project data may be stored in the long term memory of a computer, removing the need for storing, possibly the entire, first and second project data in the short term memory. Also, the data indicative of where the first project data in the first data format is stored and where the second project data in the second data format is stored allows for comparison between these and the first and second project data of the third project data.

In one embodiment, the step of storing the third project data comprises creating a database, wherein the step of storing the copied first and second project data is performed in accordance with a specific set of rules, the specific set of rules mapping the first project data in the first data format onto the database of the third project data, and mapping the second project data in the second data format onto the database of the third project data, the mapping being performed such that the copied first and second project data is organised similarly in the database of the third project data. This may ease the process of deciphering the copied first and second project data for visualisation. The step of storing the third project data may comprise storing data indicative of the first data format and the second data format, which may allow for rigorous comparison between the copied first project data in the database of the third project data with the first project data in the first data format, and similarly for the second project data.

In one embodiment, the step of visualising the first and second project data comprises visualising the third project data while omitting parts of the third project data, the omitted parts of the data comprising the data indicative of where the first project data in the first data format is stored and where the second project data in the second data format is stored. This allows for a clean visualisation of the first and second project data of the third project data, while allowing track keeping with the first project data in the first data format and the second project data in the second data format. In case the third project data comprises data indicative of the first data format and the second data format, the omitted parts of the data may also comprise the data indicative of the first data format and the second data format for a clean visualisation.

In one embodiment, the step of visualising the first and second project data includes the steps of:
comparing the first project data in the first data format with the copied first project data of the third project data;
comparing the second project data in the second data format with the copied second project data of the third project data; and
identifying any discrepancy found between corresponding project activity data.

This allows for the first project data in the first data format and the second project data in the second data format to be edited in respective project management computer programs, by, e.g., a project planner, without the need to keep track of every change made, as the method allows for automated identification of discrepancies between the copied first and second project data and the edited project data.

In one embodiment, the step of visualising the first and second project data includes visualising a notification if the comparison reveals any discrepancy between corresponding project activity data. In this case, a user visualising the copied first and second project data in the single graphical user interface, is notified if the first or second project data in the first or second data format has been edited. Accordingly, this allows a user to make sure the visualised project data is in accordance with the project data in the first and second data format.

In one embodiment, the method further comprises the step of, if any discrepancy is identified, presenting a dialog box in the single graphical user interface offering a choice between at least visualising the copied first and second project data of the third project data or visualising the first and second project data as defined by the first project data in the first data format and the second project data in the second data format.

In this case, it is particularly convenient to selectively work with the latest version of the first and second project data. For instance, a project manager may be preparing a presentation on the progress of a project as defined by the first and second project data and therefore visualising the first and second project data in the single graphical user interface. At the time of the presentation, the project manager may be notified that the project data in the first or second data format no longer corresponds to the copied first or second project data. The dialog box then allows the project manager to selectively visualise the project data as it were at the time of preparing the presentation to allow a consistent presentation as prepared, or if visualising the latest version of the project data is prioritised, visualise the project data as defined in the first and second data format. Similar advantages apply for other users.

In one embodiment, if any discrepancy is identified, the method comprises the step of storing at least fourth project data, the step of storing the at least fourth project data comprising the steps of:
storing the copied first and/or second project data of the third project data;
copying the updated first project data in the first data format and/or the updated second project data in the second data format;
storing the copied updated first and second project data; and
storing labelling data, the labelling data defining the copied first and/or second project data of the third project data as being previous, and defining the copied updated first and/or second data as being current.

In this case, the method allows for the previous project data as defined by the copied first and/or second project data to be stored in the fourth project data, while also storing the updated first and/or second project data in the fourth project data, without a risk of mixing up the project data. This allows for visualising previous project data and updated project data simultaneously for comparison.

In one embodiment, the step of storing the at least fourth project data is followed by the steps of:
comparing previous and current project activity data of the fourth project data;
visualising the fourth project data in the single graphical user interface; and
indicating, in the single graphical user interface, a difference between previous and current project activity data for at least one set of current and previous project activity data; or
selectively visualising the previous first and/or second project data, and/or the current first and/or second project data based on user input to a navigation pane.

The indication of a difference between the previous and current project activity in the single graphical user interface allows for swift identification of changes made between the previous and current version. Accordingly, a project planner looking to track diversions from the previous project activity data is handed an effective tool identifying such diversions. This may be particularly advantages when several project planners are working on the projects as defined by the first and second project data, allowing one project planner to keep track of changes made by another planner. Also, a contractor visualising the fourth project data is allowed to conveniently visualise the difference between previous and current project activity data to adjust inventory or personnel allocation if necessary. Further, the selective visualisation of the previous or current first and second project data allows a project planner to intermittently visualise the previous project data for, e.g., presentation purposes, and to visualise the current project data for, e.g., instructing a contractor.

In one embodiment, the step of storing the third project data comprises the step of defining and storing association data defining a hierarchy between the first and second project data, wherein the step of visualising the first and second project data comprises visualising, in the single graphical user interface, the hierarchy between the first and second project data as defined by the association data.

The definition and visualisation of a hierarchy between the first and second project data allows a user to organise the first and second project data in the single graphical interface according to an individual preference. For example, a project planner may have planned a plurality of first project activities defined by first project data, while a contractor has planned a plurality of second project activities defined by second project data, the plurality of second project activities constituting sub parts of the plurality of first project activities. In this case, the project planner may define and visualise the first and second project data in hierarchy with the second project data lying under the first project data. Accordingly, the hierarchical relationship between the first and second project data may conveniently be defined and visualised without the hierarchical relationship being defined by the first project data in the first data format or by the second project data in the second data format. Further, by storing the first and second hierarchies in the third project data, the hierarchies do not affect the first project data in the first data format or the second project data in the second data format.

In one embodiment, the step of storing the third project data comprises the steps of: copying fifth project data;
storing the copied fifth project data;
defining and storing association data, the association data defining a first hierarchy between the fifth project data and the first project data, and defining a second hierarchy between the fifth project data and the second project data,
wherein the step visualising the first and second project data, comprises the steps of:
visualising the first hierarchy between the fifth project data and the first project data as defined by the association data;
visualising the second hierarchy between the fifth project data and the second project data as defined by the association data; and
visualising the fifth project data.

In embodiments, the fifth project data comprises fifth project activity data defining a plurality of fifth project activities, at least one fifth project activity defining at set of activity parameters including at least start and finish time.

The definition and visualisation of the first hierarchy and the second hierarchy allows for simultaneous visualisation of the fifth project data in two different hierarchies in relation to two different sets of project data in the single graphical user interface. This versatile organisation capability may provide overview of a complex set of interdependent projects, without the project data defining the set of interdependent projects themselves defining the interdependence.

In one embodiment, the method further comprises the steps of:
identifying a project activity in the first project data;
comparing the identified project activity in the first project data to the plurality of project activities defined in the second project data; and
determining if the identified project activity in the first project file has a related project activity in the second project data,
   wherein the step of visualising the first and second project data includes visualisation of a single graphical entity in the single graphical user interface highlighting the identified project activity in the first project data and the related project activity in the second project file.

The visualisation of the single graphical entity in the single graphical interface highlighting the related project activities in the first and second project data reduces the time spend in identifying related project activities. With visualisation of the first and second project data in different individual user interfaces, such identification of related project activities would in many cases be highly time consuming in navigating through the first and second project data. For example, a project planner may have planned a plurality of first project activities defined by first project data, while a contractor has planned a plurality of second project activities defined by second project data, the plurality of second project activities constituting sub parts of the plurality of first project activities, in which case the first and second project data would comprise a set of related project activities conveniently identified by the single graphical entity.

In present context, related project activities refer to interdependent project activities so that the, e.g., the beginning of the related project activity depends on the conclusion of the identified project activity, or vice versa.

In one embodiment, the method further comprises the steps of:
identifying an activity parameter defined for at least one identified first project activity in the first project data;
comparing the identified activity parameter in the first project data to the activity parameters of the plurality of second project activities in the second project data; and
determining if the identified activity parameter has a similar activity parameter defined for at least one second project activity,
   wherein the step of visualising the first and second project data includes highlighting, in the single graphical user interface, the at least one identified first project activity and at least one second project activity having the similar activity parameter.

This allows searches across the first and second project data for project activities sharing an activity parameter, and highlighting the project activities with a shared activity in the single graphical user interface. This alleviates the user from searching in two different separate user interfaces of the mutually incompatible project management computer programs, and comparing the result of each search amongst the different user interfaces. The shared activity parameter may be any one of start time, finish time, budgeted units and resources, while other activity parameters, e.g. user defined, may also be defined such as, e.g., start up phase, evaluation phase, erection of building or status reporting.

In one embodiment, the method further comprises the steps of:
defining a third group of at least one first project activity and at least one second project activity; and
generating group data on the third group,
   wherein the step of visualising the first and second project data comprises visualising the third group of first and second project activities in the single graphical user interface.

In this case, the user is able to define the third group of project activities from both the first project data and the second project data. This cross grouping provides an overview in the single graphical user interface, while also allowing the user to simply navigating amongst the third group of project activities. With different individual user interfaces, such actions would be very cumbersome if at all possible.

In embodiments wherein the third project data is visualised, the method may advantageously comprise the step of storing the group data in the third project data. Accordingly, the group data may be stored for convenient later visualisation of the third group of project activities.

In one embodiment, the step of defining the third group of at least one first project activity and at least one second project activity comprises the steps of:
identifying a first activity parameter of a first group of at least one first project activity in the first project data;
identifying a second activity parameter of a second group of at least one second project activity in the second project data;
comparing the first and second activity parameters;
if the first activity parameter corresponds to the second activity parameter, define a third activity parameter for the third group, the third activity parameter corresponding to the first and second activity parameters; and
define the third group comprising the at least one first project activity of the first group and the at least one second project activity of the second group.

This allows for automatic grouping of first and second project activities being grouped into first and second groups with similar activity parameters. Such convenient grouping further allows for navigating and storing the automatically grouped project activities.

The activity parameters may be any one of start time, finish time, budgeted units and resources, while other activity parameters, e.g. user defined, may also be defined such as, e.g., start up phase, evaluation phase, erection of building or status reporting.

In one embodiment, the method further comprises the steps of:
defining a first filter for the first project data;
defining a second filter for the second project data; and
visualising the first project information filtered according to the first filter and the second project information filtered according to the second filter simultaneously at the single graphical user interface.

The individual filter applied to each of the first and second project data allows for tailoring of a customised view in the single graphical user interface.

In one embodiment, each step of the method leaves the first project data in the first data format and the second project data in the second data format unaltered. Accordingly, all steps of the method preserves the first project data in the first data format and the second project data in the second data format. This opens up access to the first and second project data to a whole new range of users that would otherwise not have access due to them not being authorised to alter the project data. Moreover, a project planner responsible for execution of a project can provide access for a partaker in the project to view the project data without worrying if the contractor might accidentally edit the project data.

With a view to providing access to project data to a plurality of users, the project management computer program may, in an enterprise implementation of the present invention, be at least partially executed through a user module, whereby the first and second project data may be obtained from one or more source data databases. The one more source data databases may be provided at the user module, or at a workstation or source server connected to the user module via a computer network. In particular, the one or more source data databases may store the first and second project data and may be databases of mutually incompatible project management computer programs, such as, e.g., Microsoft® Project® and Primavera Project Management. The one or more source data databases may be provided at the user module or at a facility connected to the user module, such as a separate workstation or source server. In order to provide multiple-user access to at least the third project data, multiple instances of the project management computer program for visualizing the project data may be executed by respective users. Such multiple users may access the project data by personalized login to the project management computer program, or they may remotely access the project data from multiple workstations.

In one embodiment, the step of storing the third project data is carried out through the organizer module, wherein the user module fetches the project data from the organizer module.

The step of storing the third project data may conveniently be carried out through the organizer module, whereby the user module fetches the project data, notably the third project data and optionally the fourth and/or fifth project data from the organizer module. Data may, in one embodiment, be fetched through a web interface. Data, including in particular the third, fourth and/or fifth project data may be stored or replicated at the user module, such as in a local SQLite database.

In one embodiment, the one more source data databases are provided at the source server connected to the user module via a computer network, wherein the user module obtains the first and second project data from the source server, and wherein the step of storing the third project data is carried out through the user module.

As the user module obtains the first and second project data from the source server and stores the third project data, the third project data does not need to be stored centrally on a source server but can be stored, e.g., locally on the workstation running the user module. Accordingly, each time a user module is to visualise the first and second project data, it is allowed to obtain the latest versions of said project data from the source server before storing the third project data.

Alternatively, if the user module had to obtain third project data stored on the source server via the organizer module before visualising the first and second project data, there would be a risk of visualising old project data. Moreover, in this case the organiser module would have to obtain the first and second project data from the source server and store the third project data each time the user module was to access it, to ensure that the stored third project data reflected the first and second project data on the source server. This would both make version tracking of third project data cumbersome and put extra load on the organiser module.

In one embodiment, the organizer module administers user access rights to the first and second project data on the source server, wherein the user module is only allowed to obtain the first and second project data from the source server if:
the organizer module has granted access rights to the first and second project data to a user associated with at least one authorised user ID; and
at least one authorised user ID is logged in to the user module; or
no access restrictions to the first and second project data are defined in the organizer module.

In this case, the first and second project data may be stored on the source server in a manner not taking account of user access rights, as this is handled solely by the organizer module. This allows for simple data storage as well as versatile user access rights administration.

In one embodiment, the organizer module administers user access rights to the third project data and authenticates the user operating through the user module. Creation, administration and renewal of licenses and access rights may be provided through a web interface to a license database. In one embodiment, licenses are issued, administered and/or renewed by the license database in an at least semi-anonymous manner using generated machine codes. In this case, the license database will upon issuance of a license, generate a unique machine code. The software license is then associated with this unique machine code. When the issued license is used, the user module using the license must identify itself with the unique machine code for the license to be acknowledged as authentic by the license database. The use of the unique machine code for license purposes allows the license server to authenticate a license used by a user module with little or no need of storing personal/sensitive information.

A plurality of unique machine codes and associated licenses may also be created for a super user through the web interface to the license database. The plurality of unique machine codes and associated licenses may then be distributed to individual user modules by the super user through a client web application executed by the organizer module. In one embodiment, each user module thereafter identifies itself to the license database for authorisation with a unique machine code. This allows the license database to authenticate licenses with little or no need of storing personal/sensitive information relating to any of the user modules in the license server.

In one embodiment, each of the one or more user modules, organizer module, third project data, and source data databases form part of a secured network. In present context the term ‘secured network’ is to be understood as a network separated from the internet by a data firewall for increased security. In one embodiment, the license server does not form part of the secured network. In other words, the license server may only connect to the secured network through the data firewall. This allows the license server to be administered by a license issuer with no access to the secured network.

In such embodiments, the use of unique machine codes in association with licenses allows each user module inside the secured network, to be authenticated by the license server outside the secured network, without the need to send any personal/sensitive information outside the secured network. Moreover, only the unique machine code has to be sent outside the secured network for license authentication.

In a further broadest aspect, the invention provides a method of visualising project management information deriving from a plurality of project management computer programs, comprising the steps of:
obtaining first project data in a first data format generated by a first project management computer program;
obtaining second project data in a second data format generated by a second project management computer program;
deciphering the first project data and second project data; and
simultaneously visualising the first project data and the second project data in a single graphical user interface of a project management computer program,
   wherein
the first project data comprises first project activity data defining a plurality of first project activities, at least one first project activity defining at set of activity parameters including at least start and finish time; and
the second project data comprises second project activity data defining a plurality of second project activities, at least one second project activity defining at set of activity parameters including at least start and finish time, budgeted units and one or more resources.

### BRIEF DESCRIPTION OF THE DRAWINGS

Embodiments of the invention will now be described in further detail with reference to the accompanying drawings, in which:

FIG. 1 illustrates a flow chart of project data visualisation according to embodiments;

FIGS. 2-4 illustrate a single graphical user interface visualising project data according to embodiments;

FIG. 5 illustrates a flow chart of project data visualisation according to embodiments; and

FIGS. 6-7 illustrate a single graphical user interface visualising project data according to embodiments;

FIG. 8 illustrates configuration of User Defined Fields (UDF) links;

FIG. 9 illustrates a system layout of a multiple-user implementation of the present invention;

FIGS. 10-12 illustrate graphical user interfaces of a multiple-user implementation of the present invention.

### DETAILED DESCRIPTION OF THE DRAWINGS

It should be understood that the detailed description and specific examples, while indicating embodiments, are given by way of illustration only, since various changes and modifications within the spirit and scope of the invention will become apparent to those skilled in the art from this detailed description.

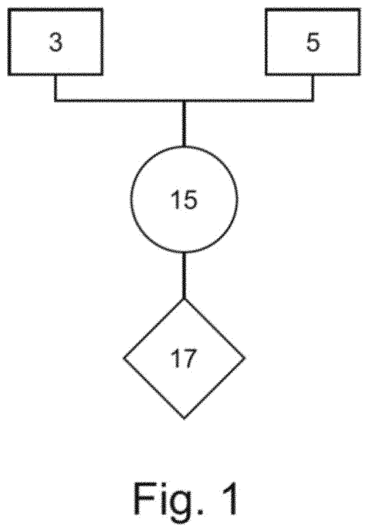

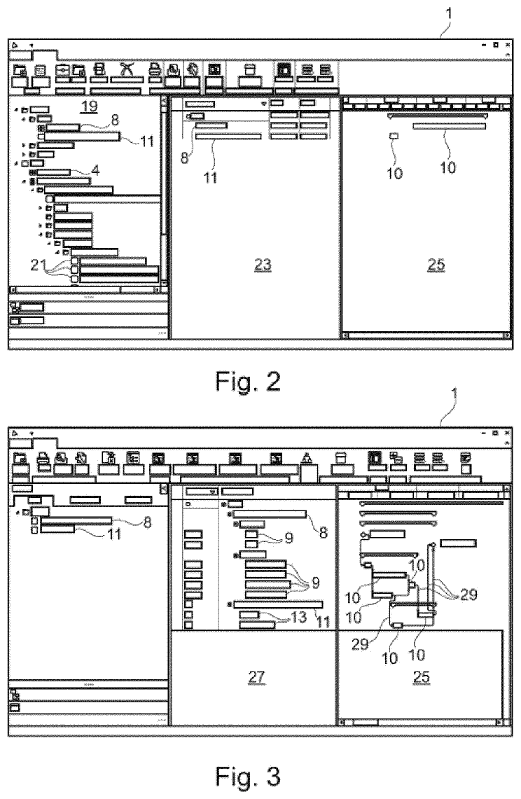

FIG. 1 illustrates a flow chart of steps of a method of visualising project management information deriving from a plurality of mutually incompatible project management computer programs in a single graphical user interface 1 according to embodiments of the invention, see also FIGS. 2-4 and 6-7.

The first step 3 of the method is obtaining first project data 8 in a first data format 4 generated by a first project management computer program. The second step 5 is obtaining second project data 11 in a second data format 7 generated by a second project management computer program. The first data format 4 is incompatible with the second project management computer program and the second data format 7 is incompatible with the first project management computer program. Accordingly, the first project management computer program is not able to visualise the second project data 11 in the second data format 7 and vice versa. The first project data 8 comprises first project activity data defining a plurality of first project activities 9, at least one first project activity defining at set of activity parameters 10 including at least start and finish time, budgeted units and one or more resources. The second project data 11 comprises second project activity data defining a plurality of second project activities 13, at least one second project defining a set of activity parameters 10 including at least start and finish time, budgeted units and one or more resources.

The third step 15 of the method is deciphering the first project data 8 and the second project data 11. The deciphering the first and second project data 8, 11 comprises reading the first and second project data in the first and second data format 4, 7 in accordance with a specified set of rules for each of the first and second data format 4, 7. Moreover, detailed knowledge of the first and second data formats 4, 7 including how the project data is organised, the order in which the project data is stored, how the data is stored and what units are used is taken into account by the specified rules. For instance, the first data format 4 may use a first time format, while the second format 7 uses a second time format. The specified set of rules takes such differences into account and allows visualisation of the first and second project data 8, 11 in the same time format. The specified set of rules also takes into account if the first project data 8 is saved as a database in the first data format 4 or stored as a file, and similarly for the second project data 11.

The fourth step 17 of the method is simultaneously visualising the first and second project data 8, 11 in the single graphical user interface 1. By use of the single graphical user interface 1 the first and second project data 8, 11 is navigable and select individual project activities of each of the first and second project data 8, 11 may be compared, see FIGS. 2-4 and 6-7 for detailed embodiments.

Accordingly, even though the first and second project data 8, 11 derive from mutually incompatible project management computer programs they are visualised in a single graphical user interface 1. This allows not only comparing static views of a certain first project activity 9 in the first project data 8 with another second project activity in the second project data 11, but also to navigate and obtain an overview of both first and second project data 8, 11 in the single graphical user interface 1. In the often complicated task of managing projects, such comparative capabilities provide improved effectivity and convenience for several groups of users. Further, in case the first project data 8 and second project data 11 share a certain project activity, perhaps at different levels of detail, the simultaneous visualisation of the first project data 8 and second project data 11 in the single graphical user interface 1 allows for simultaneous inspection of the shared project activity at different levels of detail in the first project data 8 and the second project data 11, as illustrated in FIG. 3.

By simultaneously visualising the first and second project data 8, 11 of incompatible data formats, the need for opening each of the first and second project data 8, 11 in respective incompatible project management computer programs is alleviated. This may reduce the time spend and the amount of errors made when comparing the first and second project data 8, 11, as project data no longer needs to be compared amongst the different individual user interfaces of the incompatible project management computer programs. Further, the single graphical user interface 1 allows relevant project data to be visualised alongside with a minimised distance between related project data from otherwise incompatible sets of project data.

FIG. 2 illustrates visualising first and second project data 8, 11 in a single graphical user interface 1 according to embodiments of the invention. The single graphical user interface 1 in FIG. 2 comprises a navigation pane 19 for navigating among a plurality of sets of project data. In this embodiment the method comprises the steps of obtaining further sets of project data 21 that may be deciphered and visualised upon request. In the illustrated embodiment, the further sets of project data 21 are in the same data format as the second project data 11. The single graphical user interface 1 further comprises an overview pane 23 providing the default activity parameters being names, start times and finish times for the first and second project data 8, 11, while the overview pane 23 may be customized to show a range of other desired activity parameters. At the right hand side is provided a timeline pane 25 simultaneously visualising the time spans of the first and second project data 8, 11. The single graphical user interface 1 of FIG. 2 illustrates a project view for viewing the projects at project level without specification of individual project activities.

FIG. 3 illustrates visualising first and second project data 8, 11 in a single graphical user interface 1 according to an embodiment of the invention. In FIG. 3, the single graphical user interface 1 is in activity view, in which case individual activities of each of the first and second project data 8, 11 are viewed. In the activity pane 27, the projects are expanded to view the names and IDs of each activity. In the timeline pane 25, the time line of each activity is illustrated. In the embodiment of FIG. 3, a single graphical entity 29 marks the interdependence of related project activities of the first and second project data 8, 11. The visualisation of the single graphical entity 29 in the single graphical interface highlighting the related project activities in the first and second project data 8, 11 reduces the time spend in identifying related project activities. The embodied method leading to the visualisation of FIG. 3, comprises the further steps of identifying a project activity in the first project data 8 and comparing the identified project activity in the first project data 8 to the plurality of project activities defined in the second project data 11. If the identified project activity in the first project file 8 has a related project activity in the second project data 11, the single graphical entity 29 marks the related project activity.

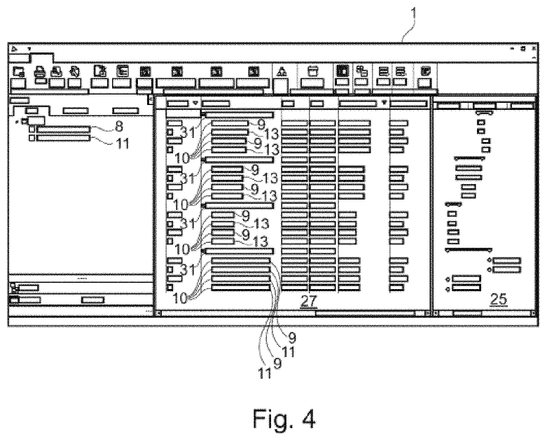

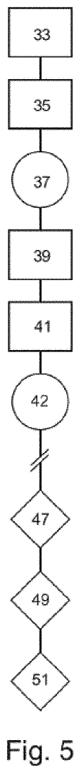

FIG. 4 illustrates visualising first and second project data 8, 11 in a single graphical user interface 1 according to an embodiment of the invention. The embodied method leading to the single graphical user interface 1 in FIG. 4 comprises the further steps of identifying an activity parameter 10, in the illustrated case being the name, for a first project activity 9, comparing the name of the first project activity 9 to that of the plurality of second project activities, and highlighting the first and second project activities with a similar name in the single graphical user interface 1. In FIG. 4, the process has been repeated several times. The method allows for swift comparison of the respective project activity timelines in the timeline pane 25.

A similar view to that illustrated in FIG. 4 may be obtained in case of defining and visualising groups of project activities from both the first and second project data 8, 11 according to embodiments of the invention. This would provide an improved overview and the possibility to navigate amongst the groups of activities. In one embodiment, the grouping is automated by performing the steps of identifying a first activity parameter 10 of a first group of at least one first project activity 9 in the first project data 8. Then identifying a second activity parameter 10 of a second group of at least one second project activity 13 in the second project data 11 followed by comparing the first and second activity parameters 10. If the first activity parameter 10 corresponds to the second activity parameter 10, the method defines a third activity parameter 31 for the third group, the third activity parameter 31 corresponding to the first and second activity parameters 10. The third group is then defined to comprise the at least one first project activity 9 of the first group and the at least one second project activity 13 of the second group. The view of FIG. 4 corresponds to four iterations of defining a third group.

FIG. 5 illustrates an embodiment of the invention in which the method comprises the further steps of copying the first and second project data 8, 11 in step 33, storing the copied first and second project data 8, 11 in step 35, and storing data indicative of where the first project data in the first data format 4 is stored and where the second project data in the second data format 7 is stored in step 37. By copying and storing the copied first and second project data 8, 11 in the third project data, the first project data in the first data format 4 and the second project data in the second data format 7 are available to be opened by other project management computer programs, while being visualised in the single graphical user interface 1. This allows for one user, e.g. a project planner, to edit parts of the first and second project data 8, 11, while another user, e.g. a contractor, is simultaneously visualising the first and second project data 8, 11 for carrying out a project activity. Also, the data indicative of where the first project data in the first data format 4 is stored and where the second project data in the second data format 7 is stored allows for comparison between these and the first and second project data 8, 11 of the third project data.

The embodiment of FIG. 5 further comprises the steps of copying fifth project data 38 in step 39, storing the copied fifth project data in step 41, and defining and storing association data in step 42. The association data defines a first hierarchy 43 between the fifth project data 38 and the first project data 8, and defines a second hierarchy 45 between the fifth project data 38 and the second project data 11. In this embodiment, the step of visualising the first and second project data 8, 11 comprises the further steps of visualising the first hierarchy 43 between the fifth project data 38 and the first project data 8 as defined by the association data in step 47, visualising the second hierarchy 45 between the fifth project data 38 and the second project data 11 as defined by the association data in step 49, and visualising the fifth project data in step 51.

The hierarchical relationship between sets of project data may conveniently be defined and visualised without the hierarchical relationship being defined by the first project data in the first data format 4, by the second project data in the second data format 7 or the fifth project data 38. Accordingly, the definition and visualisation of hierarchies 43, 45 between the first, second and fifth project data 8, 11, 38 allows a user to organise the data in the single graphical interface according to an individual preference without necessarily affected how other users view the sets of project data.

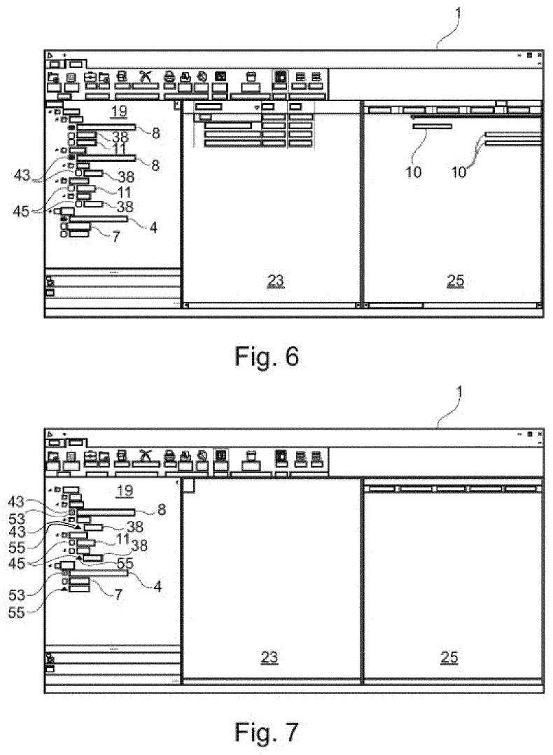

FIG. 6 illustrates a single graphical user interface 1 visualising the first hierarchy 43 between the fifth project data 38 and the first project data 8, and the second hierarchy 45 between the fifth project data 38 and the second project data 11.

FIG. 7 illustrates a single graphical user interface 1 visualising the first hierarchy 43 between the fifth project data 38 and the first project data 8, and the second hierarchy 45 between the fifth project data 38 and the second project data 11. However, the first project data in the first data format 4 has been renamed or deleted since last visualisation, which is indicated by the square icon 53 for both the first project data in the first data format 4 and the copied first project data 8. The fifth project data 38 has been altered since last visualisation indicated by the triangular icon 55.

The embodied method leading to the view of the single graphical user interface illustrated in FIG. 7 comprises the further steps of comparing the first project data in the first data format 4 with the copied first project data 8 of the third project data, comparing the second project data in the second data format 7 with the copied second project data 11 of the third project data, identifying any discrepancy found between corresponding project activity data, and visualising a notification if the comparison reveals any discrepancy. In FIG. 7 the notification is in the form of the square icon 53 or triangular icon 55.

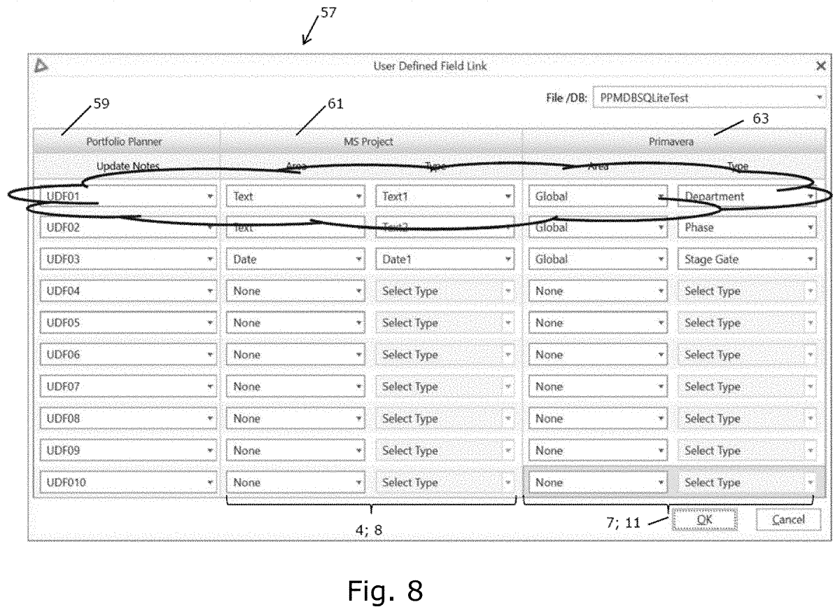

FIG. 8 illustrates an example of a method according to the invention for simultaneously visualising and administering first and second project data 8,11 in the first and second data format 4,7, respectively, notably in relation to User Defined Fields (UDF) 59, also referred herein to as user-defined project activity parameters. In one embodiment, the first project data 8 comprises a first set of user defined fields in the first data format 4 and the second project data 11 comprises a second set of user defined fields in the second data format 7. Each of the first and second set of user defined fields are, in the embodiment of FIG. 8, to be considered as user-defined project activity parameters. The left column in FIG. 8 headed ‘Portfolio Planner’ designates UDFs 59 in the data structure and graphical user interface of the present invention, whereas the middle and right columns headed ‘MS Project” and ‘Primavera’ designate UDFs 61 and 63 according to first and second data formats 4 and 7. In one embodiment of the invention, each one of the UDFs labelled ‘UDF01’ through ‘UDF010’ in FIG. 8 may be linked, i.e. set equal to, respective ones of the UDFs in the first and second data formats, i.e. those of MS Project and Primavera in the illustrated embodiment. For example, as illustrated UDF01 in the embodiment of FIG. 8 is linked to area field ‘Text’ and type ‘Text1’ in MS Project which in turn is linked to area field ‘Global’ and type field ‘Department’ in Primavera. The user's configuration of the UDF links illustrated in FIG. 8 may be stored in a layout which may include user-defined columns, filters, Gantt scaling by date, etc. The layout may be importable and exportable to/from the graphical user interface. Thus, one user may pass a UDF-link over to another user. It will be appreciated that the implementation of UDF links as illustrated in FIG. 8 allows comparison and visualization of data across projects and formats.

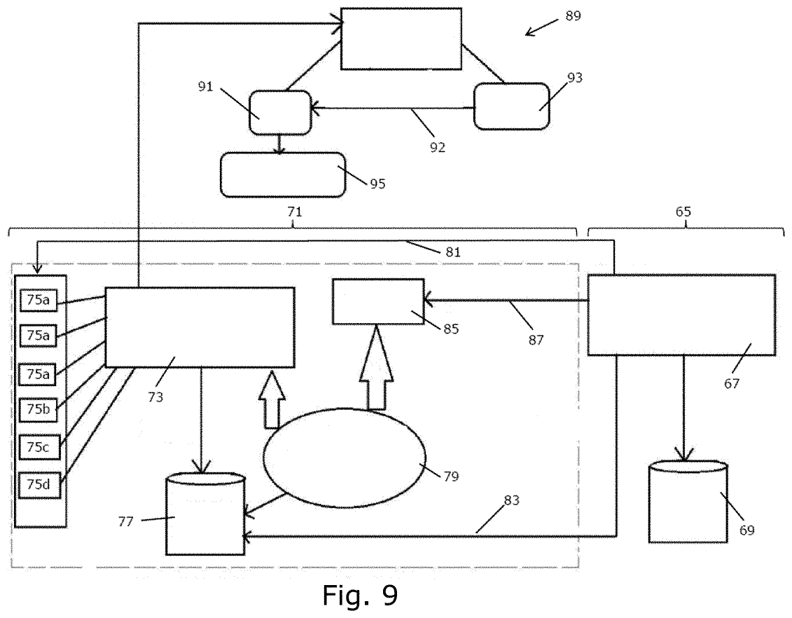

FIG. 9 illustrates a system layout of a multiple-user implementation of the present invention allowing user-defined and/or administrator-defined access to project data. The system comprises a user module, also referred to herein as an ‘Organizer User’ module 65 which executes a first software application, e.g. a so-called ‘Portfolio Planner Desktop Application’ 67 implementing the present invention at a user's workstation, and providing access to a local database 69, e.g. a SQLite database.

The multiple-user system layout illustrated in FIG. 9 further comprises an ‘Organizer’ module 71 which executes a second software application, e.g. a so-called ‘Portfolio Planner Enterprise Desktop Application’ 73 which has data access to first and second project data 75a-75d, such as in the form of Primavera databases 75a, an MSP file 75b, an SQLite database 75c, and a Primavera export file, e.g., an XER file 75d. The databases 75a-75d may be external databases, i.e. databases accessed through a computer program other than the project management computer program of the present invention, and/or the databases 75a-75d may be hosted at a separate or remote computer system. In one embodiment, the enterprise desktop application 73 exchanges project and activity data with an enterprise database 77 which stores project data, notably at least the third project data. In the exemplary embodiment shown in FIG. 9, the enterprise database 77 only stores data related to license and user management and data related to user-wise project access management as indicated at 79. In this case, project data is obtained directly from the first and second project data 75a-75d and is not stored on the enterprise database 77. As indicated by arrows 81 and 83, the user module 65 may access the first and second project data in databases 75a-75d and/or the third project data in enterprise database 77 directly. Local and/or replicated data may be stored at the local SQLite database 69.

The organizer module 71 may conveniently execute a client web application 85 which, as illustrated by arrow 87, may be accessed by the desktop application 67 for user authentication, connecting through a web API, and for user-wise data loading.

The user module 65 and organizer module 71 may be interconnected through a computer network, referred to herein also as a ‘client network’. The organizer module 71 and user modules 65 may be executed through software applications running on separate workstations, or at a common workstation. In one embodiment, the organizer module 71 is executed at a server, whereas multiple user modules 65 are executed at one or more workstations.

In one embodiment, each of the organizer module 71 and the user module 65 form part of a secured network separated from the internet by a data firewall. Such a secured network may be the intranet of an enterprise with multiple-user implementation of the present invention.

A portfolio web application 89 may be provided for providing organization login as indicated at 91, for creating organizations through super user login, as indicated at 93 and by arrow 92, and for purchasing licenses for organizer users, as indicated at 95. The license related data is in one embodiment stored on a license server. This license server may be hosted by the license issuer. In one embodiment, the license server does not form part of the secured network and is thereby arranged outside the data firewall.

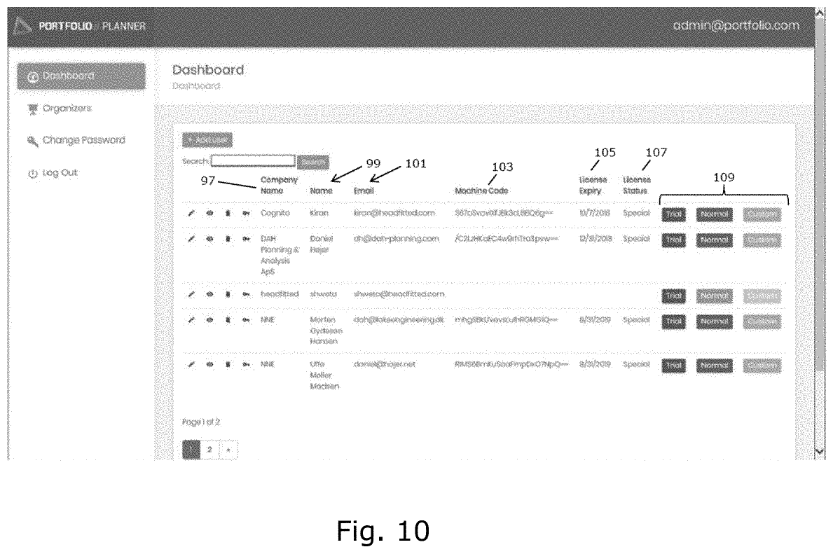

FIG. 10 illustrates a graphical user interfaces of a multiple-user implementation of the present invention for administrator use through the portfolio web application 89 (FIG. 9). FIG. 10 illustrates a dashboard listing company names 97, individual user names 99 and email addresses 101, associated machine codes 103, license expiry 105 and license status 107. At 109, the administrator has the choice between trial mode, normal mode and custom mode access to data. The dashboard illustrated in FIG. 10 thus allows an administrative user to order, purchase and renew licenses for users of the project management computer program. For convenience, and for compliance with data protection regulations, only minimal amounts of user-related and/or personal information is preferably stored, such as user name and user email address. In respect of the organizer, the stored data are preferably limited to organizer name, organization/firm name, organizer's email address, organization/firm address, country, telephone number and number of licenses. As mentioned above, all such license related data may be stored on a license server preferably hosted by the license issuer.

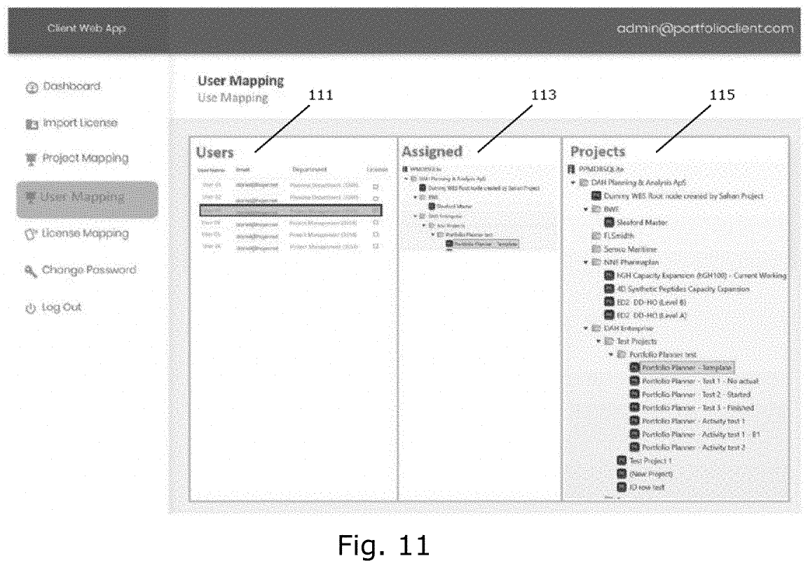

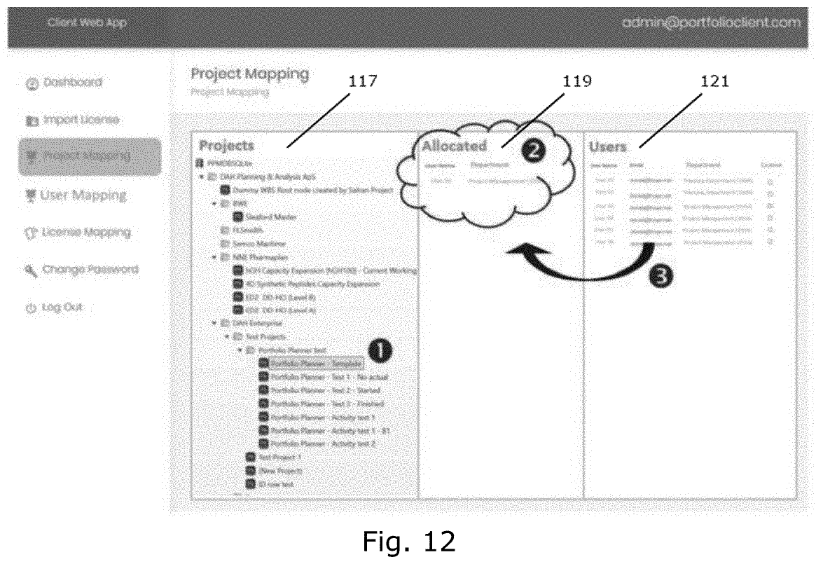

FIGS. 11-12 illustrate graphical interfaces of an embodied client web application 85 of the organizer module 71. FIG. 11 illustrates a user mapping interface listing users at 111, listing all projects at 115 and listing projects assigned to respective users at 113. Thereby the user mapping interface lets an organizer select one or more users in the user list 111, which results in the projects assigned to the selected one or more users being displayed at 113. This provide a swift overview of what and how many projects are assigned to the one or more selected users, which may help in deciding if more or less projects are to be assigned to the one or more users.

The graphical user interface of FIG. 11 further allows changing what projects are assigned to the one or more selected users. To un-assign a project from the one or more selected users at 111, the project is simple dragged from the ‘Assigned’ list at 113 and dropped in the ‘Projects’ list at 115. To assign a project to the one or more selected users at 111, the project is dragged from the ‘Projects’ list at 115 to the ‘Assigned’ list at 113.

FIG. 12 illustrates a project mapping view listing projects at 117, and users allocated to selected projects at 119 and all users at 121. Analogously to the graphical user interface of FIG. 11, the interface of FIG. 12 allows an organiser to view which users are assigned to one or more selected projects at 117 and to change the users assigned to the one or more selected projects at 117 by dragging and dropping users between the ‘Allocated’ list at 119 and the ‘Users’ list at 121.

1.-15. (canceled)

16. A method of visualising project management information deriving from a plurality of mutually incompatible project management computer programs, comprising the steps of:
obtaining first project data in a first data format generated by a first project management computer program;
obtaining second project data in a second data format generated by a second project management computer program;
deciphering the first project data and second project data; and
simultaneously visualising the first project data and the second project data in a single graphical user interface of a project management computer program,
wherein
the first project data comprises first project activity data defining a plurality of first project activities, at least one first project activity defining at set of activity parameters including at least start and finish time, budgeted units and/or one or more resources;
the second project data comprises second project activity data defining a plurality of second project activities, at least one second project activity defining at set of activity parameters including at least start and finish time, budgeted units and/or one or more resources; and
the first data format being incompatible with the second project management computer program and the second data format being incompatible with the first project management computer program.

17. The method of visualising project management information according to claim 16, wherein the method further comprises the step of storing third project data, the step of storing the third project data comprising the steps of:
copying the first and second project data;
storing the copied first and second project data; and
storing data indicative of where the first project data in the first data format is stored and where the second project data in the second data format is stored.

18. The method of visualising project management information according to claim 17, wherein the step of visualising the first and second project data comprises visualising the third project data while omitting parts of the third project data, the omitted parts of the data comprising the data indicative of where the first project data in the first data format is stored and where the second project data in the second data format is stored.

19. The method of visualising project management information according to claim 18, wherein the step of visualising the first and second project data includes the steps of:
comparing the first project data in the first data format with the copied first project data of the third project data;
comparing the second project data in the second data format with the copied second project data of the third project data; and
identifying any discrepancy found between corresponding project activity data, wherein, optionally, the step of visualising the first and second project data includes visualising a notification if the comparison reveals any discrepancy between corresponding project activity data,
the method optionally further comprising the step of, if any discrepancy is identified, presenting a dialog box in the single graphical user interface offering a choice between at least visualising the copied first and second project data of the third project data or visualising the first and second project data as defined by the first project data in the first data format and the second project data in the second data format.

20. The method of visualising project management information according to claim 19, wherein if any discrepancy is identified, the method comprises the step of storing at least fourth project data, the step of storing the at least fourth project data comprising the steps of:
storing the copied first and/or second project data of the third project data;
copying the updated first project data in the first data format and/or the updated second project data in the second data format;
storing the copied updated first and second project data; and
storing labelling data, the labelling data defining the copied first and/or second project data of the third project data as being previous, and defining the copied updated first and/or second data as being current,
wherein the step of storing the at least fourth project data is optionally followed by the steps of:
comparing previous and current project activity data of the fourth project data;
visualising the fourth project data in the single graphical user interface; and
indicating, in the single graphical user interface, a difference between previous and current project activity data for at least one set of current and previous project activity data; or
selectively visualising the previous first and/or second project data, and/or the current first and/or second project data based on user input to a navigation pane.

21. The method of visualising project management information according to claims 17, wherein the step of storing the third project data comprises the step of defining and storing association data defining a hierarchy between the first and second project data, and
wherein the step of visualising the first and second project data comprises visualising, in the single graphical user interface, the hierarchy between the first and second project data as defined by the association data.

22. The method of visualising project management information according to claim 17, wherein the step of storing the third project data comprises the steps of:
copying fifth project data;
storing the copied fifth project data;
defining and storing association data, the association data defining a first hierarchy between the fifth project data and the first project data, and defining a second hierarchy between the fifth project data and the second project data,
and wherein the step visualising the first and second project data, comprises the steps of:
visualising the first hierarchy between the fifth project data and the first project data as defined by the association data;
visualising the second hierarchy between the fifth project data and the second project data as defined by the association data; and
visualising the fifth project data.

23. The method of visualising project management information according to claim 17, wherein:
the project management computer program is executed through a user module;
the first and second project data are obtained from one or more source data databases;
the one more source data databases are provided at the user module or at a workstation or at a source server connected to the user module via a computer network;
multiple instances of the project management computer program are executed by respective users.

24. The method of visualising project management information according to claim 23, wherein the one more source data databases are provided at a source server connected to the user module via a computer network, and
wherein the user module obtains the first and second project data from the source server, and
wherein the step of storing the third project data is carried out through the user module.

25. The method of visualising project management information according to claim 24, wherein the organizer module administers user access rights to the first and second project data on the source server, and
wherein the user module is only allowed to obtain the first and second project data from the source server if:
the organizer module has granted access rights to the first and second project data to a user associated with at least one authorised user ID; and
at least one authorised user ID is logged in to the user module;
or no access restrictions to the first and second project data are defined in the organizer module.

26. The method of visualising project management information according to claim 16, wherein the method further comprises the steps of:
identifying a project activity in the first project data;
comparing the identified project activity in the first project data to the plurality of project activities defined in the second project data; and
determining if the identified project activity in the first project file has a related project activity in the second project data,
and wherein the step of visualising the first and second project data includes visualisation of a single graphical entity in the single graphical user interface highlighting the identified project activity in the first project data and the related project activity in the second project file.

27. The method of visualising project management information according to claim 16, wherein the method further comprises the steps of:
identifying an activity parameter defined for at least one identified first project activity in the first project data;
comparing the identified activity parameter in the first project data to the activity parameters of the plurality of second project activities in the second project data; and
determining if the identified activity parameter has a similar activity parameter defined for at least one second project activity,
and wherein the step of visualising the first and second project data includes highlighting, in the single graphical user interface, the at least one identified first project activity and at least one second project activity having the similar activity parameter.

28. The method of visualising project management information according to claim 16, wherein the method further comprises the steps of:
defining a third group of at least one first project activity and at least one second project activity; and
generating group data on the third group,
and wherein the step of visualising the first and second project data comprises visualising the third group of first and second project activities in the single graphical user interface.

29. The method of visualising project management information according to claim 28, wherein the step of defining the third group of at least one first project activity and at least one second project activity comprises the steps of:
identifying a first activity parameter of a first group of at least one first project activity in the first project data;
identifying a second activity parameter of a second group of at least one second project activity in the second project data;
comparing the first and second activity parameters;
if the first activity parameter corresponds to the second activity parameter, define a third activity parameter for the third group, the third activity parameter corresponding to the first and second activity parameters; and
define the third group comprising the at least one first project activity of the first group and the at least one second project activity of the second group.

30. The method of visualising project management information according to claim 16, wherein each step of the method leaves the first project data in the first data format and the second project data in the second data format unaltered.
